(19) United States
(12) Patent Application Publication
(10) Pub. No.: US 2024/0228767 A1
(43) Pub. Date: Jul. 11, 2024

(54) RESIN COMPOSITION

(71) Applicant: NAN YA PLASTICS CORPORATION, TAIPEI (TW)

(72) Inventors: Te-Chao Liao, TAIPEI (TW); Wei-Ru Huang, TAIPEI (TW); Hung-Yi Chang, TAIPEI (TW); Chia-Lin Liu, TAIPEI (TW)

(73) Assignee: NAN YA PLASTICS CORPORATION, TAIPEI (TW)

(21) Appl. No.: 18/170,561

(22) Filed: Feb. 17, 2023

(30) Foreign Application Priority Data
Dec. 23, 2022 (TW) 111149615

(51) Int. Cl. C08L 63/00

(52) U.S. Cl. CPC C08L 63/00; C08L 2201/02; C08L 2205/025; C08L 2205/035

(57) ABSTRACT

A resin composition includes an epoxy resin, a benzoxazine resin, a BMI resin, and a modified polyphenylene ether resin has a structure represented by the following formula:

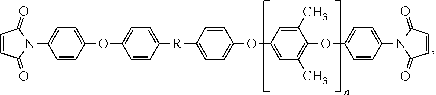

wherein R represents a chemical group of a bisphenol compound located between two hydroxyphenyl functional groups, and n is an integer ranging from 3 to 25.

### CROSS-REFERENCE TO RELATED APPLICATION

This application claims the priority benefit of Taiwan application serial no. 111149615, filed on Dec. 23, 2022. The entirety of the above-mentioned patent application is hereby incorporated by reference herein and made a part of this specification.

### BACKGROUND

### Technical Field

The present disclosure relates to a resin composition.

### Description of Related Art

The resin composition system based on epoxy resin, benzoxazine resin and bismaleimide resin as have been widely used in different industrial fields due to their maturity. However, with the evolution of technology, there are still problems (e.g., water absorption and dielectric property, etc.) that need to be improved in the aforementioned resin scheme. Therefore, it becomes an urgent goal for those skilled in the art to develop an improved and competitive resin composition system based on epoxy resin and benzoxazine resin.

### SUMMARY

The present disclosure provides a resin composition system based on epoxy resin and benzoxazine resin, which can effectively improve its performance in terms of glass transition temperature, thermal expansion coefficient, peel strength, water absorption, heat resistance, dielectric constant and/or dielectric strength and therefore provide competitive advantages.

The present disclosure provides a resin composition includes an epoxy resin, a benzoxazine resin, a BMI resin, and a modified polyphenylene ether resin has a structure represented by the following formula:

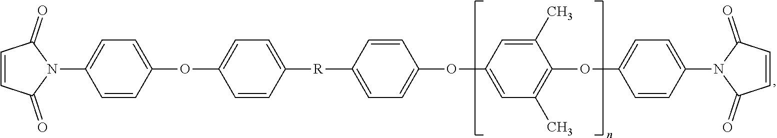

wherein R represents a chemical group of a bisphenol compound located between two hydroxyphenyl functional groups, and n is an integer ranging from 3 to 25.

In an embodiment of the present disclosure, a weight ratio of the epoxy resin to a total weight of a resin in the resin composition ranges from 40 wt % to 60 wt %.

In an embodiment of the present disclosure, a weight ratio of the benzoxazine resin to a total weight of a resin in the resin composition ranges from 20 wt % to 40 wt %.

In an embodiment of the present disclosure, a weight ratio of the modified polyphenylene ether resin to a total weight of a resin in the resin composition ranges from 10 wt % to 40 wt %.

In an embodiment of the present disclosure, the bismaleimide resin is polyphenylmethanemaleimide resin, and a weight ratio of the polyphenylmethanemaleimide resin to a total weight of a resin in the resin composition ranges from 0 wt % and 40 wt %.

In an embodiment of the present disclosure, the resin composition further includes a catalyst, a flame retardant, silicon dioxide, a siloxane coupling agent or a combination thereof.

In an embodiment of the present disclosure, a usage amount of the catalyst ranges from 0.005 phr to 1 phr.

In an embodiment of the present disclosure, a usage amount of the flame retardant is between 25 phr and 40 phr.

In an embodiment of the present disclosure, a weight ratio of the silicon dioxide to a total weight of a resin in the resin composition ranges from 30 wt % to 60 wt %.

In an embodiment of the present disclosure, a usage amount of the siloxane coupling agent ranges from 0.1 phr to 5 phr.

Based on the above, in the present disclosure, in the resin composition system based on epoxy resin, benzoxazine resin and bismaleimide resin, epoxy resin and benzoxazine resin as crosslinking agents are combined with modified polyphenylene ether resin having a specific structural formula. Accordingly, desired reaction is generated through interaction of functional groups of epoxy resin and benzoxazine resin with modified polyphenylene ether resin, and thus, the resin composition of the disclosure can effectively improve its performance in terms of glass transition temperature, thermal expansion coefficient, peel strength, water absorption, heat resistance, dielectric constant and/or dielectric strength and therefore provide competitive advantages.

In order to make the above-mentioned features and advantages of the present disclosure more comprehensible, the following specific embodiments are described in detail together with the accompanying drawings.

### DESCRIPTION OF THE EMBODIMENTS

Embodiments of the disclosure will be described in details below. However, these embodiments are illustrative, and the disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

In this embodiment, the resin composition includes an epoxy resin, a benzoxazine resin (BZ resin), a bismaleimide resin and a modified polyphenylene ether (PPE) resin having a structure represented by the following formula (1):

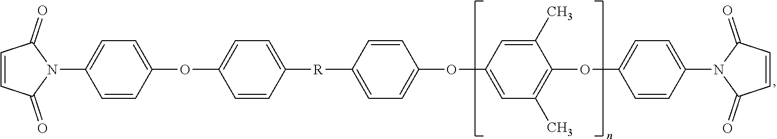

wherein R represents a chemical group of a bisphenol compound located between two hydroxyphenyl functional groups, and n is an integer ranging from 3 to 25.

In the present disclosure, in the resin composition system based on epoxy resin, benzoxazine resin and bismaleimide resin, epoxy resin and benzoxazine resin as crosslinking agents are combined with modified polyphenylene ether resin having a specific structural formula. Accordingly, desired reaction is generated through interaction of functional groups of epoxy resin and benzoxazine resin with modified polyphenylene ether resin, and thus, the resin composition of the disclosure can effectively improve its performance in terms of glass transition temperature, thermal expansion coefficient, peel strength, water absorption, heat resistance, dielectric constant and/or dielectric strength and therefore provide competitive advantages. Herein, the modified polyphenylene ether resin, epoxy resin and benzoxazine resin will be described in detail below.

Furthermore, among multiple resin-based systems, the present disclosure clearly specifies epoxy resin and benzoxazine resin based system, which can effectively improve multiple properties of the resin composition, such as glass transition temperature, thermal expansion coefficient, peel strength, water absorption, heat resistance, dielectric constant and/or dielectric loss. Based on this, the resin composition of the disclosure clearly demonstrates that it has beneficial effects in the application field of epoxy resin and benzoxazine resin based system.

In some embodiments, the resin composition may be applied to a circuit board. In the circuit board made of the resin composition of the disclosure, the dielectric constant is 3.2 to 3.5, the dielectric loss is less than 0.004, the glass transition temperature is greater than 240° C., the thermal expansion coefficient is less than 20 ppm/° C., the peel strength is greater than 4 lb/in and the water absorption rate is less than 0.4%. It demonstrates that the resin composition of the disclosure is a resin composition with low water absorption and low dielectric property. For example, in the application field of 5G communication, in order to meet the needs of high-frequency transmission of a circuit board, low water absorption and low dielectric property are required. However, the existing epoxy resin and benzoxazine resin based system has problems such as high water absorption and high dielectric property. The present disclosure clearly demonstrates that the water absorption and dielectric property of the epoxy resin and benzoxazine resin based system can be effectively reduced by the reaction of modified polyphenylene ether resin with epoxy resin and benzoxazine resin. That is to say, the resin composition of the present disclosure can have substantially improved technical performance when it is applied to 5G communication, but the present disclosure is not limited thereto.

### Epoxy Resin and Benzoxazine Resin

In some embodiments, epoxy resins can be classified into various types of epoxy resins according to different main skeletons. For example, the various types of epoxy resins can be classified into: bisphenol type epoxy resin, such as bisphenol type A epoxy resin, bisphenol F type epoxy resin, bisphenol S type epoxy resin, etc.; novolac type epoxy resin, such as biphenyl aralkyl novolak type epoxy resin, phenol novolak type epoxy resin, alkylphenol novolac type epoxy resin, cresol novolak type epoxy resin, naphthol alkylphenol copolymerized novolak type epoxy resin, naphthol aralkyl cresol copolymerized novolac epoxy resin, bisphenol A novolac epoxy resin, bisphenol F novolak epoxy resin, etc.; stilbene type epoxy resin; epoxy resin containing triazine skeleton; epoxy resin containing fennel skeleton; naphthalene type epoxy resin; anthracene type epoxy resin; triphenylmethane type epoxy resin; biphenyl type epoxy resin; xylene type epoxy resin; dicyclopentadiene epoxy resin, such as alicyclic epoxy resin, etc. Benzoxazine resin can be any suitable commercially available BZ resin, such as bisphenol A benzoxazine resin, and the present disclosure is not limited thereto.

In some embodiments, the weight ratio of epoxy resin to the total weight of the resin in the resin composition may range from 40 wt % and 60 wt % (e.g., 40 wt %, 45 wt %, 50 wt %, 55 wt %, 60 wt %, or any numerical value between 40 wt % and 60 wt %), but the present disclosure is not limited thereto.

In some embodiments, the weight ratio of benzoxazine resin to the total weight of the resin in the resin composition may range from is between 20 wt % and 40 wt % (e.g., 20 wt %, 25 wt %, 30 wt %, 35 wt %, 40 wt % or any numerical value between 20 wt % and 40 wt %, but the present disclosure is not limited thereto.

### Modified Polyphenylene Ether Resin

The manufacturing method of modified polyphenylene ether resin includes the following steps in sequence. It is noted that the sequence of the steps and the actual operation method in this embodiment may be adjusted according to the needs, and are not limited to the embodiment.

A large-molecular-weight polyphenylene ether (PPE) resin material is provided, and the large-molecular-weight polyphenylene ether resin material has a first number average molecular weight (Mn), wherein the first number average molecular weight (Mn) of the large-molecular-weight polyphenylene ether resin material is no less than 18,000, and preferably no less than 20,000, but the disclosure is not limited thereto.

The large-molecular-weight polyphenylene ether resin material has a structure represented by the following formula (1-1):

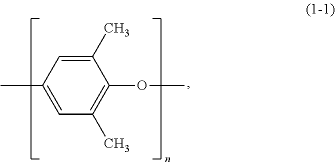

wherein n is an integer ranging from 150 to 330, and preferably ranging from 165 to 248.

In some embodiments, the polyphenylene ether resin material may also be called polyphenylene oxide (PPO). The polyphenylene ether resin material has excellent insulation, acid and alkali resistance, excellent dielectric constant, and low dielectric loss. Therefore, the polyphenylene ether resin material has more excellent electrical properties and is more suitable as an insulating substrate material for a high-frequency printed circuit board, but the present disclosure is not limited thereto.

After the large-molecular-weight polyphenylene ether resin material is provided, a cracking process is performed, such that the large-molecular-weight polyphenylene ether resin material is cracked to form a small-molecular-weight polyphenylene ether resin material having a second number average molecular weight and modified with a bisphenol functional group (also known as, a small molecule PPE with a phenolic end group), and the second number average molecular weight is smaller than the first number average molecular weight (i.e., the number average molecular weight of the polyphenylene ether resin material before cracking), wherein the second number average molecular weight (Mn) of the small-molecular-weight polyphenylene ether resin material is no more than 12,000, and preferably no more than 10,000, but the disclosure is not limited thereto.

More specifically, the cracking process includes: reacting a bisphenol (phenolic material) with a large-molecular-weight polyphenylene ether resin material having a first number average molecular weight (namely, a large-molecular-weight PPE), in the presence of peroxide, such that the large-molecular-weight polyphenylene ether resin material is cracked to form a small-molecular-weight polyphenylene ether resin material having a second number average molecular weight smaller than the first number average molecular weight, wherein one side of the polymer chain of the small-molecular-weight polyphenylene ether resin material is modified with a phenolic functional group, and its general chemical structural formula (1-2):

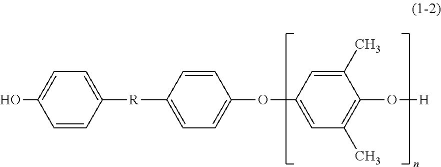

wherein R represents a chemical group of the bisphenol compound located between two hydroxyphenyl functional groups.

For example, as shown in Table 2 below, R may include a direct bond, methylene, ethylidene, isopropylidene, 1-methylpropyl, sulfone, or fluorene, wherein n is an integer between 3 and 25, and preferably between 10 and 18. In some embodiments, the number average molecular weight (Mn) of the small-molecular-weight polyphenylene ether resin material is between 500 g/mol and 5,000 g/mol, preferably between 1,000 g/mol and 3,000, and particularly preferably between 1,500 g/mol and 2,500 g/mol. In addition, the weight average molecular weight (Mw) of the small-molecular-weight polyphenylene ether resin material is between 1,000 g/mol and 10,000 g/mol, preferably between 1,500 g/mol and 5,000 g/mol, and particularly preferred is between 2,500 g/mol and 4,000 g/mol, but the disclosure is not limited thereto.

In some embodiments, the bisphenol compound is at least one material selected from the group consisting of 4,4′-biphenol, bisphenol A, bisphenol B, bisphenol S, bisphenol fluorene, 4,4′-ethylidenebisphenol, 4,4′-dihydroxydiphenylmethane, 3,5,3′,5′-tetramethyl-4,4′-dihydroxybiphenyl, and 2,2-bis(3,5-dimethyl-4-hydroxyphenyl)propane. The types of the bisphenol compounds are shown in Table 1 below.

TABLE 1

| item | bisphenol compound | CAS No. |
|---|---|---|
| 1 | 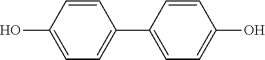 [SMILES: Oc1ccc(-c2ccc(O)cc2)cc1] | 92-88-6 (4,4′-biphenol) |
| 2 | 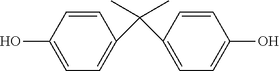 [SMILES: CC(C)(c1ccc(O)cc1)c1ccc(O)cc1] | 80-05-7 (bisphenol A) |
| 3 | 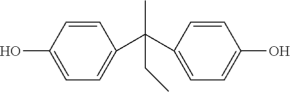 [SMILES: CCC(C)(c1ccc(O)cc1)c1ccc(O)cc1] | 77-40-7 (bisphenol B) |
| 4 | 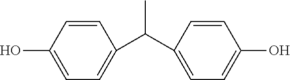 [SMILES: CC(c1ccc(O)cc1)c1ccc(O)cc1] | 2081-08-5 (4,4′-ethylidenebisphenol) |
| 5 | 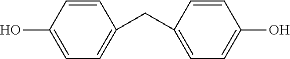 [SMILES: Oc1ccc(Cc2ccc(O)cc2)cc1] | 620-92-8 (4,4′- dihydroxydiphenylmethane) |
| 6 | 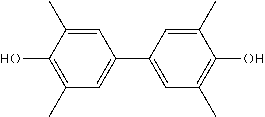 [SMILES: Cc1cc(-c2cc(C)c(O)c(C)c2)cc(C)c1O] | 2417-04-1 (3,5,3′,5′-tetramethyl-4,4′- dihydroxybiphenyl) |
| 7 | 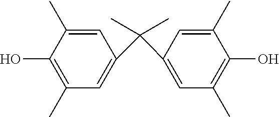 [SMILES: Cc1cc(C(C)(C)c2cc(C)c(O)c(C)c2)cc(C)c1O] | 5613-46-7 (2,2-Bis(3,5-dimethyl-4- hydroxyphenyl)propane) |
| 8 | 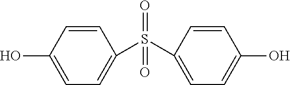 [SMILES: O=S(=O)(c1ccc(O)cc1)c1ccc(O)cc1] | 80-09-1 (bisphenol S) |
| 9 | 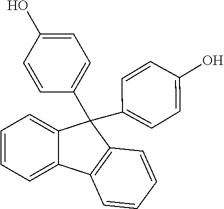 [SMILES: Oc1ccc(C2(c3ccc(O)cc3)c3ccccc3-c3ccccc32)cc1] | 3236-71-3 (bisphenol fluorene) |

The chemical groups located between the two hydroxyphenyl functional groups of the above bisphenol compounds are shown in Table 2.

TABLE 2

| | | chemical groups located between the two |
|---|---|---|
| | | hydroxyphenyl functional groups of the |
| item | bisphenol compound | bisphenol compound |
| 1 | 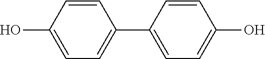 [SMILES: Oc1ccc(-c2ccc(O)cc2)cc1] | direct bond |
| 2 | 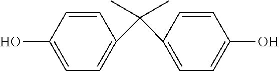 [SMILES: CC(C)(c1ccc(O)cc1)c1ccc(O)cc1] | isopropylidene |
| 3 | 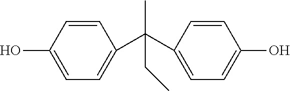 [SMILES: CCC(C)(c1ccc(O)cc1)c1ccc(O)cc1] | 1-methylpropyl(or sec-butyl) |
| 4 | 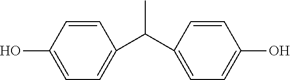 [SMILES: CC(c1ccc(O)cc1)c1ccc(O)cc1] | ethylidene |
| 5 | 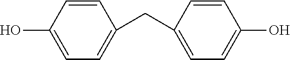 [SMILES: Oc1ccc(Cc2ccc(O)cc2)cc1] | methylene |
| 6 | 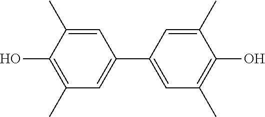 [SMILES: Cc1cc(-c2cc(C)c(O)c(C)c2)cc(C)c1O] | direct bond |
| 7 | 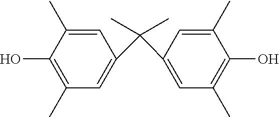 [SMILES: Cc1cc(C(C)(C)c2cc(C)c(O)c(C)c2)cc(C)c1O] | isopropylidene |
| 8 | 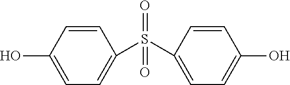 [SMILES: O=S(=O)(c1ccc(O)cc1)c1ccc(O)cc1] | sulfone |
| 9 | 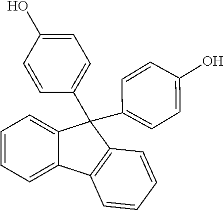 [SMILES: Oc1ccc(C2(c3ccc(O)cc3)c3ccccc3-c3ccccc32)cc1] | fluorene |

In some embodiments, the material of the peroxide is at least one selected from the group consisting of azobisisobutyronitrile, benzyl peroxide, and dicumyl peroxide. The materials of the peroxides are shown in Table 3 below.

TABLE 3

| item | peroxide | CAS No. |
|---|---|---|
| 1 | 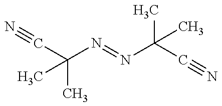 | 78-67-1 (azobissobutyro- nitrile) |
| 2 | 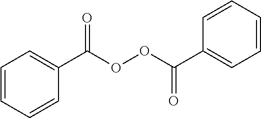 [SMILES: O=C(OOC(=O)c1ccccc1)c1ccccc1] | 94-36-0 (benzyl peroxide) |
| 3 | 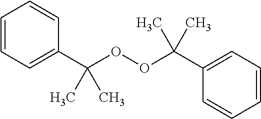 [SMILES: CC(C)(OOC(C)(C)c1ccccc1)c1ccccc1] | 80-43-3 (dicumyl peroxide) |

After the cracking process is performed, a nitrification process is performed, such that the small-molecular-weight polyphenylene ether resin material is subjected to the nitrification reaction, and thus, the two ends of the polymer chain of the small-molecular-weight polyphenylene ether resin material are respectively modified with nitro functional groups (also known as PPE with terminal nitro groups), and its general chemical structural formula (1-3) is as follows:

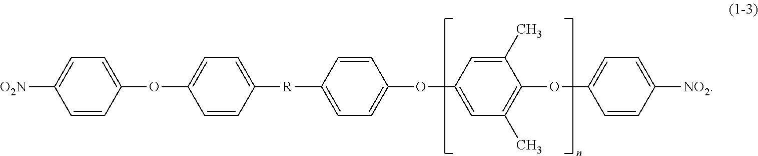

More specifically, the nitrification process includes: performing a nitrification by reacting a 4-halo nitrobenzene material with the small-molecular-weight polyphenylene ether resin material that has been cracked and modified with the bisphenol functional group in an alkali environment, such that the two ends of the polymer chain of the small-molecular-weight polyphenylene ether resin material are respectively modified with nitro functional groups. The nitrification is carried out by reacting the 4-halo nitrobenzene material with the small-molecular-weight polyphenylene ether resin material in an alkaline environment, and the ends of the polymer chain of the small-molecular-weight polyphenylene ether resin material will form negatively charged oxygen ions. The negatively charged oxygen ions easily attack 4-halo nitrobenzene to remove the halogen from 4-halo nitrobenzene, and the nitrobenzene functional groups are further respectively modified to the two ends of the polymer chain of the small-molecular-weight polyphenylene ether resin material. That is to say, the two ends of the polymer chain of the small-molecular-weight polyphenylene ether resin material may be respectively modified with nitro functional groups through the above reaction mechanism.

In some embodiments, the polyphenylene ether resin material is subjected to the nitrification process in an alkaline environment with a pH value between 8 and 14, and preferably between 10 and 14, but the disclosure is not limited thereto.

In some embodiments, the general chemical structural formula of the 4-halo nitrobenzene material is

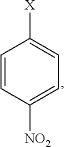

and the material types are shown in Table 4 below, wherein X is halogen, and preferably fluorine (F), chlorine (CI), bromine (Br), or iodine (I).

TABLE 4

| item | 4-halo nitrobenzene | CAS No. |
|---|---|---|
| 1 | 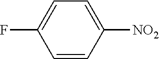 | 350-46-9 |
| 2 | 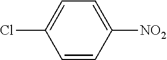 | 100-00-5 |
| 3 | 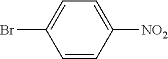 | 586-78-7 |
| 4 | 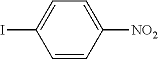 | 636-98-6 |

After the nitrification process is performed, a hydrogenation process is performed, such that the small-molecular-weight polyphenylene ether resin material with nitro functional groups at two ends of the polymer chain thereof is hydrogenated, and thus, the two ends of the chain of the small-molecular-weight polyphenylene ether resin material are respectively modified with amino functional groups (also known as PPE with terminal amino groups), and its general chemical structural formula (1-4) is as follows:

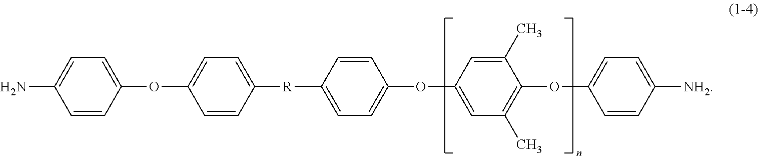

More specifically, the hydrogenation process includes: performing a hydrogenation by reacting a hydrogenation solvent with the small-molecular-weight polyphenylene ether resin material having nitro functional groups respectively modified at two ends of the polymer chain, wherein the material type of the hydrogenation solvent is selected from at least one of the material groups includes dimethylacetamide (DMAC, CAS No. 127-19-5), tetrahydrofuran (THF, CAS No. 109-99-9), toluene (CAS No. 108-88-3), and isopropanol (CAS No. 67-63-0). In some embodiments, the use of dimethylacetamide as the hydrogenation solvent can enable the hydrogenation process to achieve an excellent hydrogenation conversion rate (such as the hydrogenation conversion rate greater than 99%), but the disclosure is not limited thereto. It is noted that the parameters controlling the hydrogenation conversion rate include: (1) solvent selection and the ratio of mixed solvents, (2) catalyst addition amount, (3) hydrogenation reaction time, (4) hydrogenation reaction temperature, and (5) hydrogenation reaction pressure. The material types of the hydrogenated solvents are shown in Table 5 below.

TABLE 5

| item | hydrogenation solvent | CAS No. |
|---|---|---|
| 1 | 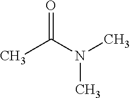 | 127-19-5 (N,N-dimethylacetamide) |
| 2 | 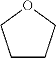 | 109-99-9 (tetrahydrofuran) |
| 3 | 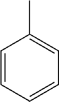 | 108-88-3 (toluene) |
| 4 | 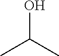 | 67-63-0 (isopropanol) |

After the hydrogenation process is performed, a synthesis process is performed. The synthesis process includes: reacting maleic anhydride with the small-molecular-weight polyphenylene ether resin material having amino functional groups respectively modified at two ends of the polymer chain (also known as PPE with terminal amino groups) that is formed in the above hydrogenation process, so as to synthesize a modified polyphenylene ether resin having a general chemical structural formula (1-5) as follows:

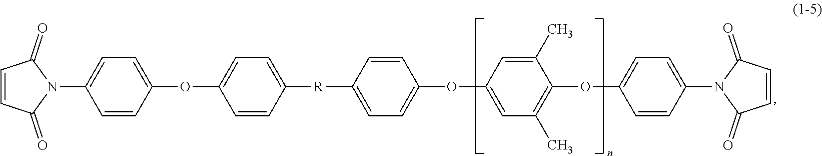

wherein R represents a chemical group of a bisphenol compound located between its two hydroxyphenyl functional groups, and n is an integer between 3 and 25, and preferably between 10 and 18,

The chemical structure of the maleic anhydride is as follows:

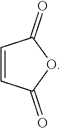

More specifically, in the synthesis process, the small-molecular-weight polyphenylene ether resin material having amino functional groups respectively modified at two ends of the polymer chain (also known as PPE with terminal amino groups) is first mixed with maleic anhydride to perform a ring-opening reaction, and p-toluene-sulfonic acid as a dehydrating agent is further added to perform a ring-closing reaction, and thus, a modified polyphenylene ether resin is synthesized. It is noted that the modified polyphenylene ether resin in above step having bismaleimide respectively modified at two ends of the polymer chain, and its chemical structure has polyphenylene ether as a main chain, while the terminal ends of the polymer chain are modified into reactive groups with high heat resistance (namely, bismaleimide). Thereby, the synthesized resin material has relatively low dielectric constant and dielectric loss. According to the above series of material modification procedures, the large-molecular-weight polyphenylene ether resin material is cracked into a small-molecular-weight polyphenylene ether resin material, the molecular structure of the small-molecular-weight polyphenylene ether resin material is then modified into having a bisphenol functional group, and the two ends of the polymer chain of the small-molecular-weight polyphenylene ether resin material are further modified with bismaleimide.

In some embodiments, the weight ratio of the modified polyphenylene ether resin to the total weight of the resin of the resin composition ranges from 10 wt % to 40 wt % (e.g., 10 wt %, 15 wt %, 20 wt %, 25 wt %, 30 wt %, 40 wt % or any value between 10 wt % and 40 wt %), but the disclosure is not limited thereto.

In some embodiments, the resin composition further includes phenylmethane maleimide resin (CAS number: 67784-74-1; such as BMI-2300 (made by Daiwa Chemical Industry Co., Ltd., trade name) having a structural formula (A) as below, wherein the weight ratio of the phenylmethane maleimide resin to the total weight of the resin of the resin composition may range from 0 wt % to 40 wt % (e.g., 5 wt %, 10 wt %, 20 wt %, 30 wt %, 40 wt % or any value between 0 wt % and 40 wt %), but the disclosure is not limited thereto. The phenylmethane maleimide resin may be optionally excluded from the resin composition. In other words, the usage amount of the phenylmethane maleimide resin can be reduced after the addition of the modified polyphenylene ether resin. Similarly, bis-(3-ethyl-5-methyl-4-maleimidephenyl)methane (CAS number: 105391-33-1; such as BMI-70 (manufactured by KI Chemical Co., trade name) having a structural formula (B) as below, may be optionally excluded from the resin composition.

### Structural Formula (A):

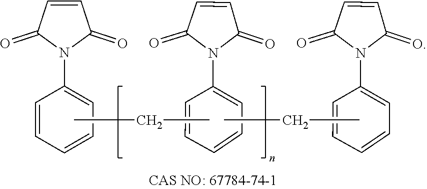

### Structural Formula (B):

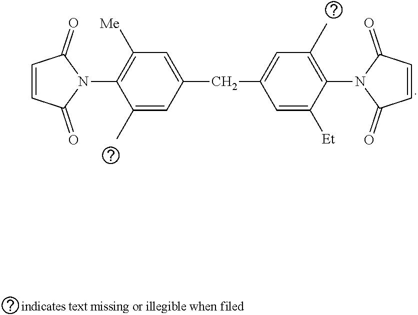 [SMILES: CCc1cc(Cc2cc(C)c(N3C(=O)C=CC3=O)c(C)c2)cc(C)c1N1C(=O)C=CC1=O]

In some embodiments, the resin composition further includes a catalyst, a flame retardant, silicon dioxide, a siloxane coupling agent, or a combination thereof, wherein the usage amount of catalyst ranges from 0.005 phr to 1 phr (e.g., 0.005 phr, 0.01 phr, 0.05 phr, 0.1 phr, 0.5 phr, 1 phr or any value between 0.005 phr and 1 phr), the usage amount of flame retardant ranges from 25 phr to 40 phr (e.g., 25 phr, 30 phr, 32 phr, 34 phr, 38 phr, 40 phr or any value between 25 phr and 40 phr), the weight ratio of silicon dioxide ranges from 30 wt % to 60 wt % (e.g., 30 wt %, 35 wt %, 40 wt %, 45 wt %, 50 wt %, 60 wt % or any value between 30 wt % to 60 wt %), the usage amount of the siloxane coupling agent ranges from 0.1 phr to 5 phr (e.g., 0.1 phr, 0.5 phr, 1 phr, 2 phr, 3 phr, 5 phr or any value between 0.1 phr and 5 phr), but the disclosure is not limited thereto. Herein, the unit “phr” may be defined as parts by weight of other materials added per 100 parts by weight of the resin of the resin composition. The weight ratio of silicon dioxide is based on the weight of the resin of the resin composition plus the weight of the flame retardant, wherein the resin of the resin composition includes, for example but not limited thereto, epoxy resin, benzoxazine resin, modified polyphenylene ether and bismaleimide resin.

In some embodiments, the catalyst may be 2-ethyl 4-methylimidazole (2E4MZ; CAS: 931-36-2;

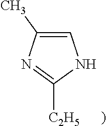

) to catalyze better reaction of epoxy resin, benzoxazine resin, modified polyphenylene ether and bismaleimide resin during thermal curing, but the disclosure is not limited thereto.

In some embodiments, the flame retardant is a halogen-free flame retardant and a specific example may be a phosphorus-based flame retardant. The phosphorus-based flame retardant may be selected from phosphate ester, such as triphenyl phosphate (TPP), resorcinol diphosphate (RDP), bisphenol A bis(diphenyl) phosphate (BPAPP), bisphenol A bis(dimethyl) phosphate (BBC), resorcinol diphosphate (CR-733S), resorcinol-bis(di-2,6-dimethylphenyl phosphate) (PX-200); may be selected from phosphazene, such as polybis(phenoxy)phosphazene (SPB-100); may be selected from ammonium polyphosphate, such as melamine phosphate (MPP), melamine cyanurate; may be selected from more than one combination of DOPO flame retardants, such as DOPO (such as having a structural formula (C)), DOPO-HQ (such as having a structural formula (D)), double DOPO derivative structure (such as having a structural formula (E)), etc.; may be selected from aluminum-containing hypophosphite (such as having a structural formula (F)),

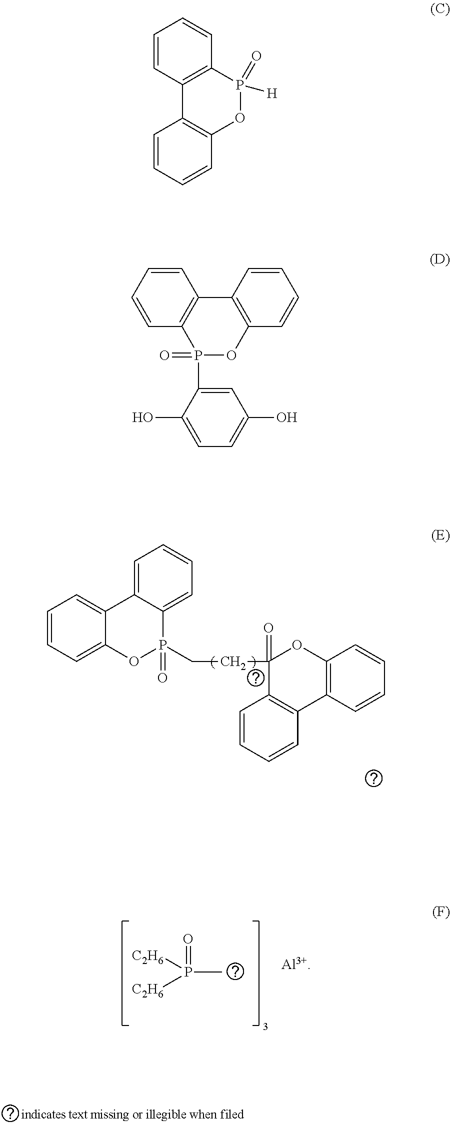

In some embodiments, the silicon dioxide (or called “silica” in some examples) is a spherical silica and may preferably be prepared using a synthetic method to reduce electrical properties and maintain fluidity and gel filling properties, wherein the spherical silica has acrylic or vinyl surface modification, the purity is above 99.0%, and the average particle diameter (D50) is about 2.0 μm to 3.0 μm, but the disclosure is not limited thereto.

In some embodiments, the siloxane coupling agents may include, for example but not limited to, siloxane compounds. In addition, according to the types of functional groups, the siloxane coupling agents may be divided into amino silane compounds, epoxy silane compounds, vinyl silane compounds, ester silane compounds, hydroxyl silane compounds, isocyanate silane compounds, methylacryloxysilane compounds and acryloxy silane compounds, for enhancing the compatibility and cross-linking degree of the glass fiber cloth and powder in the circuit board, but the disclosure is not limited thereto.

It is noted that the resin compositions of the disclosure can be processed into prepregs and copper foil substrates (or called “copper clad laminates (CCL)” in some examples) according to actual design requirements, and the specific implementations listed above are not limitations of the disclosure, as long as the resin composition system including epoxy resin, benzoxazine resin and modified polyphenylene ether resin belong to the protection scope of the disclosure.

The following examples and comparative examples are listed to illustrate the effects of the disclosure, but the protection scope of the disclosure is not limited to the examples.

The copper foil substrates in the respective examples and comparative examples were evaluated based on the following methods.

“Glass transition temperature (° C.)” is tested by using a dynamic mechanical analyzer (DMA).

“Water absorption (%)” is calculated by the weight change of the sample before and after heating the sample in a pressure cooker at 120° C. and 2 atm for 120 minutes.

“288° C. solder heat resistance (seconds)” indicates immersing the sample in a soldering furnace at 288° C. after heating the sample in a pressure cooker at 120° C. and 2 atm for 120 minutes, and recording the time required for sample explosion/delamination.

“Dielectric constant Dk” is measured by using a dielectric analyzer (model HP Agilent E4991A) to test the dielectric constant at a frequency of 10 GHz.

“Dissipation factor Df” (or called “dielectric loss” in some examples) is measured by using a dielectric analyzer (model HP Agilent E4991A) to test the dissipation factor at a frequency of 10 GHz.

“Thermal expansion coefficient (CTE)” is tested with a thermomechanical analyzer (TMA).

“Copper foil peel strength (lb/in)” is measured the peel strength between the copper foil and the circuit carrier is tested.

### Examples 1 to 2 and Comparative Example 1

Each resin composition shown in Table 6 was mixed with toluene to form a thermosetting resin composition varnish. The varnish was impregnated with Nanya fiberglass cloth (cloth type 1078LD from Nanya Plastics Cooperation) at room temperature. A prepreg with a resin content of 70 wt % was obtained after drying for several minutes at 170° C. (in impregnator). Finally, 4 pieces of the prepregs were stacked layer by layer between two layers of 35 μm thick copper foils. Under a pressure of 25 kg/cm² and a temperature of 85° C., a constant temperature was kept for 20 minutes. Then, after heating to 210° C. at a heating rate of 3° C./min, a constant temperature was kept again for 120 minutes. Then, the temperature was slowly cooled down to 130° C. to obtain a 0.59 mm thick copper foil substrate. Herein, the modified polyphenylene ether resin in Table 6 is formed by following steps: a cracked small-molecule PPE (Mn=1,600) was placed and dissolved in a solvent of dimethylacetamide, potassium carbonate and tetrafluoronitrobenzene were added, the temperature was raised to 140° C. and reacted for 8 hours and the temperature was cooled to room temperature. The solution was filtered to remove the solid and precipitated with methanol/water, so as to obtain the precipitated product (PPE-NO₂). The product (PPE-NO₂) was then placed in the solvent of dimethylacetamide, and hydrogenated at 90° C. for 8 hours, so as to obtain the product PPE-NH₂. The product PPE-NH₂ was placed in toluene, maleic anhydride and p-toluenesulfonic acid were added, the temperature was raised to 120° C., refluxed and reacted for 8 hours, so as to obtain the modified polyphenylene ether resin.

The physical properties of the copper foil substrates as prepared were tested. The results are shown in Table 6. After comparing the results of Examples 1 to 2 and Comparative Example 1 in Table 6, the following conclusions may be drawn. As compared with Comparative Example 1, Examples 1 to 2 can effectively improve their performance in terms of glass transition temperature, thermal expansion coefficient, peel strength, water absorption, heat resistance, dielectric constant and/or dielectric loss, etc.

TABLE 6

| | | | | | | Comparative | |
|---|---|---|---|---|---|---|---|
| | | Example | | | | Example | |
| | | 1 | | 2 | | 1 | |
| Resin (100 parts by | bisphenol type A epoxy resin | 40 | wt % | 40 | wt % | 40 | wt % |
| weight in total) | bisphenol A benzoxazine resin | 30 | wt % | 30 | wt % | 30 | wt % |
| | modified polyphenylene ether resin | 15 | wt % | 30 | wt % | 0 | |
| | bismaleimide resin (BMI-2300) | 15 | wt % | 0 | | 30 | wt % |
| Other additives | flame retardant (Jinyi Chemical PQ60) | 30phr | | 30phr | | 30phr | |
| (relative to 100 parts | silicon oxide | 50 | wt % | 50 | wt % | 50 | wt % |
| by weight of resin) | catalyst (2E4MZ) | 1phr - | | 1phr | | 1phr | |
| | siloxane coupling agent | 0.5phr | | 0.5phr | | 0.5phr | |
| | (methacryloxysilane compound) | | | | | | |

| B-stage curing temperature | 130° | C. | 130° | C. | 130° | C. |
|---|---|---|---|---|---|---|
| Glass transition temperature | 265° | C. | 252° | C. | 278° | C. |
| thermal expansion coefficient | 16 | ppm/° C. | 18 | ppm/° C. | 13 | ppm/° C. |
| Peel strength | 4.05 | lb/in | 4.52 | lb/in | 3.79 | lb/in |
| water absorption (PCT ½ hour) | 0.35% | | 0.31% | | 0.42% | |
| heat resistance (PCT ½ hour) | Pass | | Pass | | Pass | |
| water absorption (PCT 2 hour) | 0.42% | | 0.37% | | 0.51% | |
| heat resistance (PCT 2 hour) | Pass | | Pass | | Pass | |
| dielectric constant (Dk)/dielectric loss (Df)(measurement | 3.39/0.00447 | | 3.35/0.00398 | | 3.42/0.00513 | |
| frequency 10 GHz) | | | | | | |

It is noted that although the above-mentioned circuit board is used as an example, the application field of the epoxy resin and benzoxazine resin based system of the disclosure is not limited to the field of circuit boards. For examples, those skilled in the art can apply the resin composition of the disclosure to other related fields that require water-absorbing and heat-resistant coating materials, so these related fields all belong to the protection scope of the disclosure.

In summary, in the present disclosure, in the resin composition system based on epoxy resin, benzoxazine resin and bismaleimide resin, epoxy resin and benzoxazine resin as crosslinking agents are combined with modified polyphenylene ether resin having a specific structural formula. Accordingly, desired reaction is generated through interaction of functional groups of epoxy resin and benzoxazine resin with modified polyphenylene ether resin, and thus, the resin composition of the disclosure can effectively improve its performance in terms of glass transition temperature, thermal expansion coefficient, peel strength, water absorption, heat resistance, dielectric constant and/or dielectric strength and therefore provide competitive advantages.

Although the disclosure has been disclosed in the above embodiments, the embodiments are not intended to limit the disclosure. Persons skilled in the art may make some changes and modifications without departing from the spirit and scope of the disclosure. The protection scope of the disclosure shall be defined by the appended claims.

What is claimed is:

1. A resin composition, comprising:
an epoxy resin;
a benzoxazine resin;
a bismaleimide resin; and
a modified polyphenylene ether resin having a structure represented by the following formula: 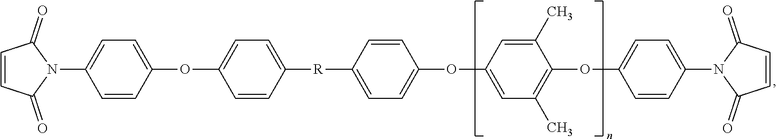
wherein R represents a chemical group of a bisphenol compound located between two hydroxyphenyl functional groups, and n is an integer ranging from 3 to 25.

2. The resin composition according to claim 1, wherein a weight ratio of the epoxy resin to a total weight of a resin in the resin composition ranges from 40 wt % to 60 wt %.

3. The resin composition according to claim 1, wherein a weight ratio of the benzoxazine resin to a total weight of a resin in the resin composition ranges from 20 wt % to 40 wt %.

4. The resin composition according to claim 1, wherein a weight ratio of the modified polyphenylene ether resin to a total weight of a resin in the resin composition ranges from 10 wt % to 40 wt %.

5. The resin composition according to claim 1, wherein the bismaleimide resin is polyphenylmethanemaleimide resin, and a weight ratio of the polyphenylmethanemaleimide resin to a total weight of a resin in the resin composition ranges from 0 wt % and 40 wt %.

6. The resin composition according to claim 1, further comprising a catalyst, a flame retardant, silicon dioxide, a siloxane coupling agent or a combination thereof.

7. The resin composition according to claim 6, wherein a usage amount of the catalyst ranges from 0.005 phr to 1 phr.

8. The resin composition according to claim 6, wherein a usage amount of the flame retardant is between 25 phr and 40 phr.

9. The resin composition according to claim 6, wherein a weight ratio of the silicon dioxide to a total weight of a resin in the resin composition ranges from 30 wt % to 60 wt %.

10. The resin composition according to claim 6, wherein a usage amount of the siloxane coupling agent ranges from 0.1 phr to 5 phr.
